(19) United States
(12) Patent Application Publication
(10) Pub. No.: US 2005/0174045 A1
(43) Pub. Date: Aug. 11, 2005

(54) Organic light-emitting device display having a plurality of passive polymer layers

(75) Inventors: Chung J. Lee, Fremont, CA (US); Atul Kumar, Santa Clara, CA (US); Chieh Chen, Palo Alto, CA (US); Yuri Pikovsky, San Jose, CA (US)

Correspondence Address: ALLEMAN HALL MCCOY RUSSELL & TUTTLE LLP, 806 SW BROADWAY, SUITE 600, PORTLAND, OR, 97205-3335, US

(73) Assignee: Dielectric Systems, Inc.

(21) Appl. No.: 11/071,764

(22) Filed: Mar. 2, 2005

Related U.S. Application Data
(63) Continuation-in-part of application No. 11/009,285, filed on Dec. 8, 2004.
Application No. 11/009,285 is a continuation-in-part of application No. 10/116,724, filed on Apr. 4, 2002, now Pat. No. 6,881,447.

(51) Int. Cl. H01J 1/62

(52) U.S. Cl. 313/504

(57) ABSTRACT

An organic light-emitting display is disclosed, wherein the organic light-emitting display includes a thin film transistor portion including an array of thin film transistors, and a light-emitting portion including an array of organic light-emitting elements in electrical communication with the array of thin film transistors, wherein the light-emitting portion is formed from a plurality of layers of materials, and wherein the plurality of layers of materials in the light-emitting portion includes a plurality of passive polymer layers each formed from a single polymer material. Systems and methods for forming organic light-emitting displays are also disclosed.

### CROSS-REFERENCES TO RELATED APPLICATIONS

This application is a continuation-in-part of U.S. patent application Ser. No. 11/009,285, filed Dec. 8, 2004, which is a continuation-in-part of U.S. patent application Ser. No. 10/116,724, filed Apr. 4, 2002. This application is also related to U.S. patent application Ser. No. ______ of Chung J. Lee, Atul Kumar, Chieh Chen and Yuri Pikovski entitled SYSTEM AND METHOD FOR FORMING AN ORGANIC LIGHT-EMITTING DEVICE DISPLAY HAVING A PLURALITY OF PASSIVE POLYMER LAYERS which was filed on ______, 2005, the same day as the present application. All of these related applications are incorporated by reference in their entirety for all purposes.

### TECHNICAL FIELD

The present disclosure relates to an organic light-emitting device display, and more particularly to an organic light-emitting device display having a plurality of passive polymer layers.

### BACKGROUND

Displays utilizing organic light-emitting devices (OLEDs) have shown great promise as thinner, lighter-weight displays for the displacement of current liquid crystal displays (LCDs). This is due at least to the lower power consumption, wider view angle, better brightness, video-speed capability and simpler and lower cost manufacturing processes of OLED displays relative to LCDs.

An OLED is a device that utilizes an organic species (either a small molecule or a polymer) to emit light under an applied electric field. Currently there are two fundamentally different OLED architectures: top-emitting OLEDs (TOLEDs) and bottom-emitting OLEDs (BOLEDs). Each of these device architectures typically includes a cathode and an anode, at least one of which is transparent, and one or more organic light-emitting layers disposed between the cathode and the anode. Application of an electric field across the cathode and anode causes electrons and holes respectively to be injected into the organic layers and move through the device. The holes and electrons may combine in the organic layers to form excited molecular species (“exitons”), which may then emit light via decay to the ground state. Emitted light can exit the OLED through the transparent electrode or electrodes.

In a TOLED, a transparent electrode is deposited over the organic light-emitting layers. In this configuration, light is emitted from the device through the face opposite the substrate on which the device is formed. In contrast, in a BOLED, the transparent electrode is deposited before the organic light-emitting layers such that light is emitted from the device through the substrate.

In addition to the layers described above, OLEDs also typically include multiple layers of passive materials. For example, a barrier layer may be used between the organic light-emitting material and an electrode to prevent the cathode material from contaminating the organic light-emitting material. This layer also may help prevent damage to the organic layer caused by the deposition of the inorganic layer. Likewise, a protective layer may be used between a color filter and an anti-reflective layer to help prevent damage to the color filter caused by the deposition of the anti-reflective layer. Also, a planarization layer may be used over an organic light-emitting layer to provide a planar surface for the deposition of a color filter. Furthermore, an encapsulation layer may be used to protect the cathode and organic light-emitting materials from harmful materials in the external atmosphere.

OLED displays include both an array of OLEDs and an array of thin film transistors (TFTs) for controlling the OLEDs. An OLED display can thus be manufactured in two discreet major steps—first, the fabrication of the TFT array, and then the fabrication of the OLED array. The TFTs in the TFT array are electrically connected to the OLEDs in the OLED array through an interconnecting metal. Therefore, OLED displays also include a passive intermetal dielectric layer to insulate the TFT-OLED interconnects.

Currently, many different materials are used in the various passive layers of OLED displays. For example, the gate dielectrics in the TFT structures are typically formed from inorganic oxides such as silicon oxide. Likewise, the intermetal dielectric between the TFT array and the OLED array is typically formed from inorganic oxides such as silicon oxide, fluorinated silicon oxide and fluorinated silicon glass (FSG). Well structures for separating organic emitters of different colors are typically formed from a spin-on photo-sensitive polyimide or acrylate. Furthermore, parylene-N (unsubstituted polyparaxylylene) has been tested as barrier layer between the organic light-emitting layers and ITO.

The various materials used as the passive layers in OLED displays are generally selected based upon the desired physical properties for each layer. However, the use of different materials for each passive layer in an OLED display may increase the cost and difficulty of manufacturing OLED displays due to the number of different tool sets that may be required to deposit all of the desired materials. Therefore, there remains a need for improved OLEDs and materials for use as passive layers in OLED displays, and for improved systems and methods for manufacturing OLED displays with fewer tool sets compared to known methods.

### SUMMARY

An organic light-emitting display is provided, wherein the organic light-emitting display includes a thin film transistor portion including an array of thin film transistors, and a light-emitting portion including an array of organic light-emitting elements in electrical communication with the array of thin film transistors, wherein the light-emitting portion is formed from a plurality of layers of materials, and wherein the plurality of layers of materials in the light-emitting portion includes a plurality of passive polymer layers each formed from a single polymer material. Systems and methods for forming organic light-emitting displays are also provided.

### BRIEF DESCRIPTION OF THE DRAWINGS

FIG. 1 shows a schematic view of an exemplary embodiment of a system for forming an OLED display.

FIG. 2 shows a greatly magnified, schematic view of an exemplary embodiment of a top-emitting OLED display.

FIG. 3 shows a greatly magnified, schematic view of an exemplary embodiment of a well or separator structure for separating organic light-emitting materials of different color.

FIG. 4 shows a greatly magnified, schematic view of an exemplary embodiment of a bottom-emitting OLED display.

FIG. 5 shows a greatly magnified, schematic view of an exemplary embodiment of a bottom-emitting polymer light-emitting device display.

FIG. 6 shows a greatly magnified, schematic view of an exemplary embodiment of an OLED-on-silicon display.

FIG. 7 shows a schematic view of another exemplary embodiment of a system for forming an OLED display.

### DETAILED DESCRIPTION OF THE DEPICTED EMBODIMENTS

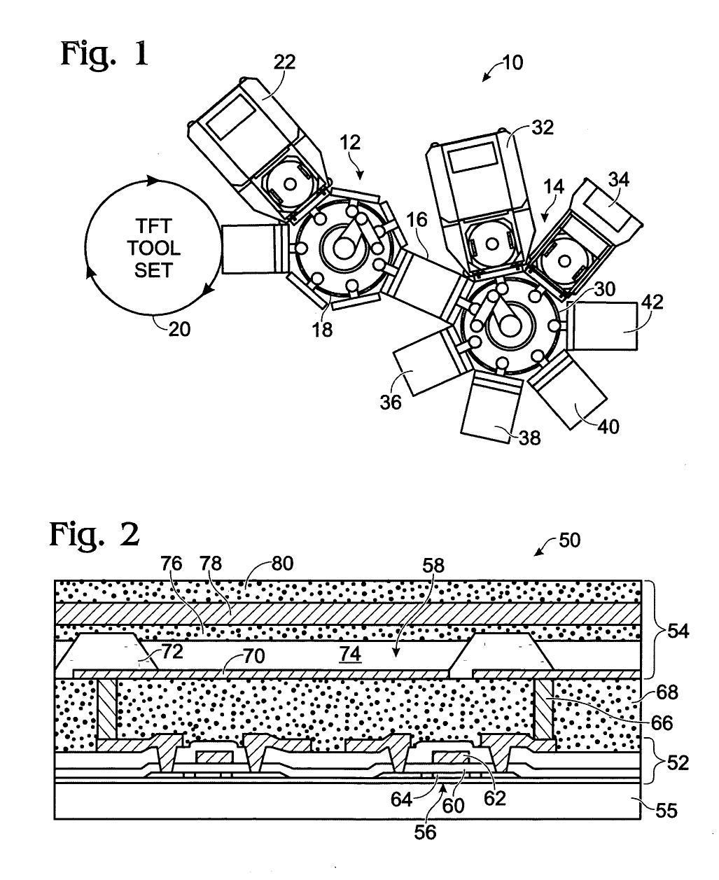

FIG. 1 shows, generally at 10, an exemplary embodiment of a system for producing both the TFT and OLED portions of an OLED display. System 10 includes a TFT fabrication section 12 and an OLED fabrication section 14. TFT fabrication section 12 includes tools for fabricating the TFT control portion of an OLED display, and OLED fabrication section 14 includes tools for fabricating the light-emitting OLED portion of an OLED display. TFT fabrication section 12 and OLED fabrication section 14 are connected by a transfer chamber 16, allowing substrates to be moved freely between the TFT fabrication 12 and the OLED fabrication section 14 without breaking vacuum.

TFT fabrication section 12 includes a central cluster-style transfer chamber 18, and various modules coupled to the TFT transfer chamber 18. For example, a tool set 20 for creating the transistors in the TFT portion of a display may be coupled to the TFT transfer chamber 18. TFT tool set 20 may be coupled directly to TFT transfer chamber 18 so that substrates can be transferred from TFT tool set 20 to TFT transfer chamber 18 without breaking vacuum, or substrates may be exposed to ambient during transfer between TFT tool set 20 and ambient. Tool sets for forming TFT arrays are outside the scope of this disclosure, and are therefore not shown or described in further detail.

A plasma etching chamber 22 may also be coupled to TFT transfer chamber 18. Plasma etching chamber 22 is typically used for etching metallic (typically aluminum) interconnects that extend between the transistors in the TFT and OLED portions of an OLED display. Plasma etching chamber 22 also may be used for etching other layers, as described below. The aluminum deposition tools (not shown) and tools for creating the interconnect layer and pattern (not shown) may be included in the TFT toolset 20, or may be coupled directly to TFT transfer chamber 18. While plasma etching chamber 22 is shown as being coupled to TFT transfer chamber 18, it will be appreciated that plasma etching chamber 22 may also be included as a part of TFT toolset 20.

OLED fabrication section 14 includes a plurality of modules coupled to a centrally disposed OLED transfer chamber 30. First, OLED fabrication section 14 includes a thermal chemical vapor deposition system 32 for depositing polymer films via transport polymerization. OLED fabrication section 14 also includes a sputtering chamber 34 for depositing anode, cathode, and/or other sputtered materials. Furthermore, OLED fabrication section 14 includes a red-emitter deposition chamber 36, a green-emitter deposition chamber 38, and a blue-emitter deposition chamber 40 for depositing red-emitting, green-emitting and blue-emitting organic materials, respectively. Alternatively, organic emitter chambers 36, 38 and 40 may be configured to deposit materials for emitting any other suitable colors. Additionally, OLED fabrication section 14 may include an auxiliary chamber 42, such as a second sputtering chamber, an annealing chamber, etc. Furthermore, if greater throughput is desired, auxiliary chamber 42 may be an additional thermal chemical vapor deposition chamber, or for depositing other organic layers, such as hole and/or electron transport layers, etc. Moreover, an annealing chamber (not shown) could be connected to TFT transfer chamber if desired.

As mentioned above, known OLEDs and OLED displays typically include a plurality of passive layers. Where each passive layer is formed from a different material, different deposition chambers may be used for forming each passive layer. However, where a single material (or a small number of similar materials) is used to form a plurality of passive layers, fewer deposition chambers may be used in the overall OLED display fabrication line. Moreover, where a single material is used to form each passive layer in either the OLED portion of the display, the TFT portion of the display, or both, a single deposition chamber may be used to form each of the passive layers. This may allow significant cost savings to be realized, as it may be possible to use fewer total tool sets for the display fabrication.

The proper selection of materials for the passive layers may allow a single material to be used for many, or all, passive layers in at least the OLED portion of an OLED display. Suitable passive materials include, but are not limited to, polymers with a repeating unit having a general formula of (—CZ¹Z²-Ar—CZ³Z⁴-), wherein Ar is an aromatic (unsubstituted, partially substituted or fully substituted), and wherein Z¹, Z², Z³ and Z⁴ are similar or different. In specific embodiments, Ar is C₆H₄₋ₓXₓ, wherein X is a halogen, and Z¹, Z², Z³ and Z⁴ are the same or different and each individually is H, F or an alkyl or aromatic group. Such films are referred to herein as “parylene-based” films. In one specific embodiment, a partially fluorinated parylene-based polymer known as “PPX-F” is used. This polymer has a repeat unit of (—CF₂—C₆H₄—CF₂—), and may be formed from various precursors, including but not limited to BrCF₂—C₆H₄—CF₂Br. In another specific embodiment, fully fluorinated poly(paraxylylene) (“FPPX-F”) is used. This polymer has a repeat unit of (—CF₂—C₆F₄—CF₂—). In yet another specific embodiment, unfluorinated poly(paraxylylene) (“PPX-N”) is used. This polymer has a repeat unit of (—CH₂—C₆H₄—CH₂—). It will be appreciated that these specific embodiments of parylene-based polymer films are set forth for the purposes of example, and are not intended to be limiting in any sense.

The above-described semi-crystalline parylene-based polymer films may be formed via the CVD technique of transport polymerization, as disclosed in U.S. Pat. No. 6,797,343 to Lee, which is hereby incorporated by reference. Transport polymerization involves generating a gas-phase reactive intermediate from a precursor molecule at a location remote from a substrate surface and then transporting the gas-phase reactive intermediate to the substrate surface for polymerization. For example, PPX-F may be formed from the precursor BrCF₂—C₆H₄—CF₂Br by the removal of the bromine atoms into the reactive intermediate *CF₂—C₆H₄—CF₂* (wherein * denotes a free radical) at a location remote from the deposition chamber, as described in U.S. patent application Ser. No. 10/854,776 of Lee et al., filed May 25, 2004, the disclosure of which is hereby incorporated by reference. This reactive intermediate may then be transported into the deposition chamber and condensed onto a substrate surface, where polymerization takes place. Careful control of deposition chamber pressure, reactive intermediate feed rate and substrate surface temperature can result in the formation of a parylene-based polymer film having a high level of initial crystallinity. The film may then be annealed to increase its crystallinity and, in some cases, to convert it to a more dimensionally and thermally stable phase. Methods for forming semi- and highly crystalline parylene-based polymer films are described in U.S. Pat. No. 6,703,462 to Lee, the disclosure of which is hereby incorporated by reference.

It has been found that parylene-based polymer films of significant initial crystallinity (equal to or greater than approximately 10%) may be formed via transport polymerization by condensing the reactive intermediate onto a cooled substrate surface. Where the substrate temperature is in an optimal range, reactive intermediate molecules adsorb to the substrate surface with sufficient energy to reorient themselves along crystal axes before polymerization, thereby forming generally aligned polymer chains.

The conditions under which such crystalline growth occur may depend upon other variables besides the substrate temperature, including but not limited to, the system pressure, reactive intermediate feed rate, and system leak rate (system leakage can introduce free-radical scavengers, such as oxygen, water, etc. from the outside atmosphere that can terminate growth of the chains of the parylene-based polymers). In the specific example of PPX-F, examples of suitable ranges for these variables include, but are not limited to, the following: deposition chamber pressures of approximately 1 to 100 mTorr (and, in specific embodiments, approximately 5 to 25 mTorr); substrate temperatures of approximately 10 to −80 degrees Celsius; leakage rates of approximately 2 mTorr/min or less (and, in specific embodiments, as low as 0.4 mTorr/min or less); and reactive intermediate feed rates of approximately 1 to 20 sccm. It will be appreciated that these ranges are merely exemplary, and that processing conditions outside of these ranges may also be used to produce passive polymer layers.

The crystallinity of an as-deposited, semi-crystalline parylene-based polymer film may be improved by annealing the film after deposition. This may be advantageous in some situations, as highly crystalline polyparylene-based films may have better moisture and oxygen barrier characteristics than less crystalline, unannealed films. The use of an annealing process may improve the crystallinity of the semi-crystalline parylene-based polymer film from the initial 10% to as high as 70%, thereby improving the moisture and oxygen barrier properties of the resulting film. While annealing may significantly improve the moisture- and oxygen-barrier properties of a semi-crystalline parylene-based polymer film, it will be appreciated that even an as-deposited and un-annealed semi-crystalline parylene-based polymer film formed via the methods described herein may have sufficient crystallinity to be useful as various passive layers.

Annealing may also convert the semi-crystalline parylene-based polymer barrier films to more thermally stable phases. Many parylene-based polymers, including but not limited to PPX-F and PPX-N, may have several different solid phases that exist at different temperatures and/or pressures. For example, the phase diagram of PPX-F includes at least an alpha phase, a beta-1 phase and a beta-2 phase. The alpha phase is a solid phase that exists at lower temperatures. When forming a PPX-F film by transport polymerization onto a substrate, relatively large amounts of alpha phase material may be initially formed. PPX-F undergoes an irreversible phase transition between the alpha phase and beta-1 phase when heated to a temperature of approximately 200-290° C. Therefore, an annealing step may be used to convert an as-deposited PPX-F film to a more dimensionally stable beta-1 phase. Furthermore, PPX-F undergoes a reversible beta-1 to beta-2 phase transition at a temperature of 350-400° C. It has been found that PPX-F films can be trapped in the beta-2 phase by first heating to a temperature above the beta-1 to beta-2 phase transition temperature on a hotplate or in an oven, holding the PPX-F film at 350 to 400° C. for a duration of, for example, 2 to 30 minutes, and then cooling the film at a fairly rapid rate, for example, between 30 and 50° C./sec, to a temperature below the beta-1 to beta-2 phase transition temperature. In this case, an annealing step followed by a rapid cooling step may be used to trap a film in a beta-2 phase so that, in the event that the film will have to undergo further processing steps at temperatures higher than the beta-1 to beta-2 phase transition temperature, no dimension-changing beta-1 to beta-2 phase transition will occur. Furthermore, the annealing may be performed under a reductive atmosphere, such as hydrogen mixed with nitrogen or argon, to cap any unreacted polymer chain ends. It will be appreciated that the annealing and cooling conditions described above are merely exemplary, and that suitable annealing conditions outside of the stated ranges may also be used. Furthermore, it will be appreciated that the annealing concepts described above may be extended to other polymer films that have similar or different solid phase boundaries.

FIG. 2 shows, generally at 50, a highly magnified, schematic cross-sectional depiction of a TOLED display. This figure illustrates both how an OLED display may be fabricated via system 10, and the various passive layers that may be formed from polymer deposited in chamber 32. It will be appreciated that the proportions of the various layers shown in FIG. 2 may be exaggerated for purposes of clarity.

Generally, TOLED display 50 includes a TFT portion 52 and an OLED portion 54 formed on a substrate 55. TFT portion 52 includes a plurality of CMOS transistor structures 56 for controlling electrical signals to a plurality of OLEDs 58 in OLED portion 54. Each TFT includes a gate dielectric 60 insulating a gate structure 62 from a channel structure 64. Gate dielectric 60 is typically formed from sputtered silicon dioxide due to the electrical requirements of the TFTs. TFT portion 52 is fabricated via TFT tool set 20, and is not described in further detail herein.

OLED portion 54 is electrically connected to TFT portion 52 by a plurality of interconnects 66. Interconnects 66 are typically formed from aluminum, but may be formed from any other suitable electrical conductor. To form interconnects 66, a layer of aluminum is deposited onto the TFT portion 52 in an Al deposition chamber (not shown), and then interconnects 66 are formed by plasma etching in plasma etching chamber 22.

After forming interconnects 66, removal of substrate 55 from the vacuum environment of system 10 may risk the oxidation of interconnects by moisture and/or oxygen in the outside atmosphere. Therefore, substrate 55 may be transferred directly into OLED transfer chamber 30 (via transfer chamber 16) and immediately into polymer deposition chamber 32 for deposition of an intermetal dielectric layer 68.

As mentioned above, known OLED displays typically utilize an inorganic intermetal dielectric material, for example, silicon dioxide, fluorinated silicon oxide and fluorinated silicon glass as an intermetal dielectric layer. These materials are utilized because of the physical properties required of the intermetal dielectric layer 68. For example, due to the separation of interconnects 66 in higher resolution OLED displays, the intermetal dielectric layer 68 needs a dielectric constant equal to or lower than approximately 4. Furthermore, due to the need to withstand later processing steps, the intermetal dielectric layer 68 should be thermally stable at temperatures of at least 400-450° C.

Instead of utilizing an inorganic intermetal dielectric, TOLED display 50 utilizes a parylene-based material as intermetal dielectric layer 68. In one specific embodiment, TOLED display 50 utilizes a PPX-F intermetal dielectric layer 68. The use of PPX-F as intermetal dielectric layer 68 may offer advantages over other parylene-based materials. For example, PPX-F is thermally stable at temperatures of 400-450° C., and can be trapped in a dimensionally stable beta-2 phase when cooled quickly from these temperatures. Furthermore, PPX-F has a dielectric constant on the order of 2.3 or lower, depending upon whether the PPX-F film is porous or non-porous, amorphous or crystalline, etc. Additionally, the transport polymerization process utilized herein may be better suited for covering large substrates than the plasma deposition of silicon oxides, because a plasma tool with a large deposition chamber can be very expensive, and it can be difficult to control film uniformity when using a large plasma deposition chamber.

After depositing intermetal dielectric layer 68, the substrate 55 may next be moved into sputtering chamber 34 for deposition of the anode 70, which in one specific embodiment may be aluminum. Anode 70 may be patterned via lithographic or non-lithographic techniques, for example, via the use of a shadow mask. The use of lithographic techniques may require the substrate 55 to be removed from system 10 for deposition and development of the resist material, while the use of a non-lithographic technique may allow avoidance of such steps. Where lithographic techniques are used, etching may be performed in plasma etching chamber 22.

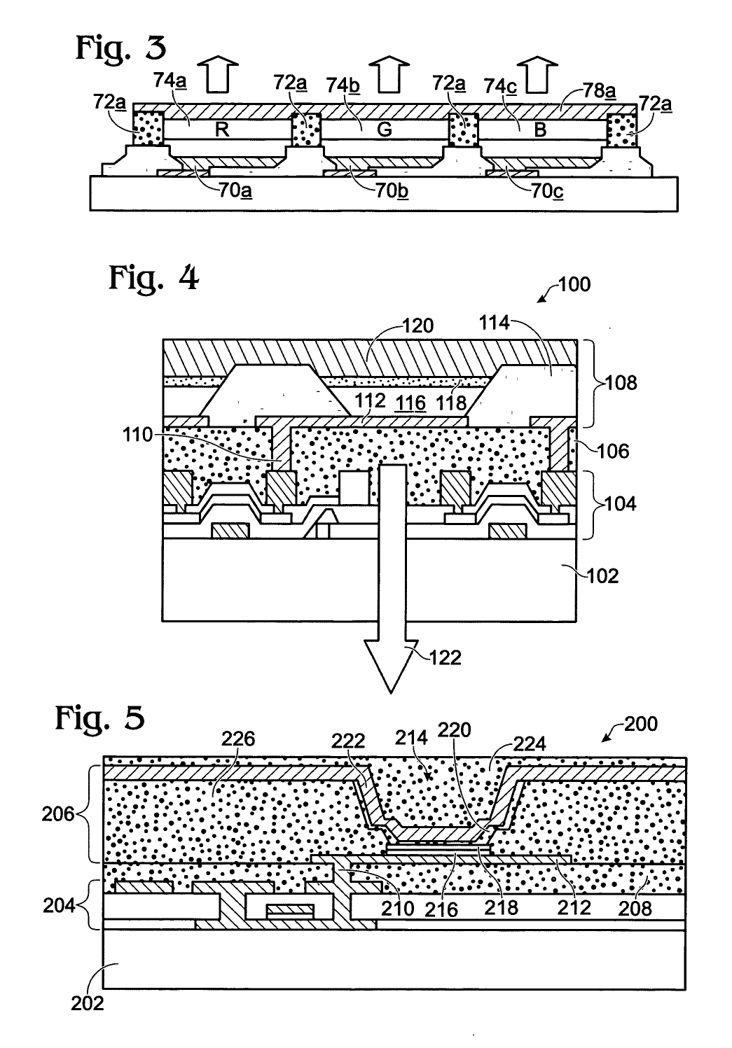

Next, separators (or well structures) 72 are formed to separate adjacent pixels in the display 50, and/or to separate organic light emitters 74 of different colors. Separators 72 may be used when constructing a color OLED display by depositing organic light-emitting materials for emitting light of different colors. One method (not using separators) of making a color OLED display is to utilize a single organic light-emitting material that emits white light, and then to use color filters to create RGB pixels. However, this may be inefficient from a power point of view, as much of the emitted light is absorbed by the filters and not emitted by the display. Therefore, another method of forming a color OLED display is to first form an array of separators or well structures 72, and then to deposit organic materials (polymers or small molecules) for emitting red, blue and green light into separate well structures via inkjet printing. FIG. 3 shows a schematic view of how such well structures, indicated at 72a, can be used to separate organic light emitters of three separate colors 74a, 74b, and 74c. In FIG. 3, each organic light emitter has one unshared electrode 70a, 70b, 70c, and all three emitters share another electrode 78a.

Conventionally, such separators 72 have been formed from photo-sensitive polyimides or acrylates by first spinning on the material, and then patterning the material using conventional techniques. However, the spin-on processes used typically have low yields, on the order of approximately 5%, and the photosensitive polyimides can be expensive. Furthermore, the polyimides and polyacrylates can absorb up to 3-4% water by mass. The low work function cathode materials used in some OLEDs, as well as some organic light-emitting materials, may be sensitive to oxidation by moisture. Therefore, the use of a polyimide or polyacrylate material in direct contact with the cathode 70 and organic light-emitting materials 74 may risk the integrity of the cathode 70 and organic light-emitting material 74.

In contrast, TOLED display 50 utilizes a parylene-based polymer separator 72, and in specific embodiments, TOLED display 50 utilizes a PPX-F separator 72. The use of a PPX-F separator offers the advantages that the PPX-F material does not absorb moisture, and also that the PPX-F material can be deposited by a clean, easily controllable transport polymerization CVD process, rather than a solvent-based spin-on deposition process. Also, compared to other parylene-based polymers, PPX-F offers the further advantages of higher crystallinity, better solvent resistance, higher Young's modulus, dimensional stability through thermal cycles, and absence of water absorption. Furthermore, a PPX-F separator 72 having dimensions on the order of 2-3 microns in height and thickness and 20-30 microns in separation, can be constructed by depositing a 2-3 micron layer of PPX-F, patterning the layer with photoresist and then plasma etching under either an N2/H2 or an NH₃ atmosphere. Alternatively, the PPX-F can be patterned using contact mask and plasma or other high energetic sources such as X-ray, excimer UV or electron beam sources. This process, in conjunction with the inkjet printing of the organic color emitters into the well structures, may offer the additional advantage of potentially enabling web-based roll-to-roll production methods.

The dielectric and moisture-barrier properties of the material used to make separators 72 may have less effect on the performance of separators 72 than these properties may have on other layers. Therefore, in the specific example of a PPX-F separator 72, the PPX-F film from which separators 72 are formed may be deposited at a potentially wide range of temperatures, feed rates, and/or pressures, including atmospheric pressure conditions, as long as care is taken to avoid the introduction of free-radical scavengers into the deposition system. This may allow large substrates to be processed in a cost-effective manner.

After forming separators 72, organic light-emitting layer 74 may be deposited in the areas defined by the separators. The material may be deposited by ink-jet printing, evaporation, or by any other suitable method, depending upon the organic light-emitting material or materials to be used in organic light-emitting layer 74. Where system 10 is used to form TOLED 50, RGB chambers 36, 38 and 40 may be used to deposit the organic light-emitting material or materials.

Next, a thin barrier layer 76 may be deposited over organic light-emitting layer 74. Barrier layer 76 may be used to protect organic light-emitting layer 74 from damage caused by the sputter deposition of cathode 78 onto the device. In the absence of a barrier layer 76, direct sputtering of cathode materials, such as ITO, can sometimes create short circuits through the organic light-emitting material or materials due to the presence of sputter-induced damage. The use of thin barrier layer 76 can help prevent such damage, and therefore may help to increase manufacturing yields.

Barrier layer 76 may be configured to have a thickness sufficient to protect the underlying organic light-emitting layer 74 from damage, yet not so thick as to detrimentally impact current flow through the organic light-emitting layer. In the specific example of a barrier layer made of a parylene-based polymer, suitable thicknesses for barrier layer 76 include, but are not limited to, thicknesses in the range of between 10-50 angstroms thick. One specific embodiment includes a barrier layer 76 having a thickness of approximately 20-30 angstroms.

Any suitable parylene-based polymer may be used as barrier layer 76. Examples may include, but are not limited to, PPX-F, PPX-N, PPX-D (—CH₂—C₆H₄Cl₂—CH₂—), and PPX-C (—CH₂—C₆H₃C₁—CH₂—) deposited by transport polymerization. In contrast, polymers that are deposited by spin-on processes may not be suitable for use as barrier layer 76. For example, it may be very difficult to control the thickness of a spin-coated polymer film with sufficient precision to form an approximately 20 micron thick film across a large substrate.

The use of PPX-F may offer advantages of higher dielectric breakdown strength and greater resistance to oxygen and water vapor permeation over other parylene-based films. Furthermore, the specific transport polymerization processes through which PPX-F films are formed may allow more precise control of the film thickness relative to the deposition of other types of parylene-based films. For example, PPX-N is generally deposited via a method known as the Gorham method. This involves the evaporating a solid dimer having a formula of (CH₂C₆H₄CH₂)₂ at temperatures ranging from 125-160° C. to create a sufficient vapor pressure of the dimer, and then controlling the feed rate of the precursor into a deposition chamber via a needle valve. However, the deposition rate may be difficult to control with sufficient precision utilizing a needle valve. A high temperature vapor phase controller may be used in place of a needle valve to provide a higher degree of control of the deposition rate. However, the high temperatures (>160° C.) required to maintain the dimer in the vapor phase may significantly shorten the lifetime of the electronics in the vapor phase controller.

In contrast, the deposition of PPX-F can be performed using a precursor heated to approximately 70° C. using a vapor phase controller operated at a temperature of approximately 120° C. Such conditions may have less of a shortening effect on the lifetime of the high temperature vapor phase controller. Furthermore, the PPX-F film thickness may also be controlled by controlling the temperature of the substrate during deposition, as cooling the substrate may cause more intermediate to adsorb to the substrate from the vapor phase, and therefore may increase deposition rates.

After depositing the barrier layer, the transparent cathode 78 is sputtered onto the barrier layer. This may be performed in the same sputtering chamber 34 in which the cathode material was deposited, or may be performed in auxiliary chamber 42.

After forming anode 78, the OLED may be capped with an encapsulant layer 80 to help protect the organic layers from degradation by the external environment, which may be caused by oxidation of these layers by oxygen and moisture in the atmosphere. Encapsulant layer 80 may be formed from a sputtered inorganic oxide (such as Al₂O₃ or SiO₂), a suitable parylene-based polymer, or both. Examples of encapsulant structures formed from alternating layers of parylene-based polymers and inorganic layers are disclosed in the above-incorporated U.S. patent application Ser. No. No. 11/009,285. Where an encapsulant layer formed from alternating layers of polymer and inorganic layers is used, auxiliary deposition chamber 42 may be configured to sputter the inorganic material, or an additional sputtering target may be provided in sputtering chamber 34 so that both electrodes and the inorganic encapsulant are all sputtered in the same chamber.

As described above, depending upon the parylene-based polymer materials used for the passive polymer layers in the OLED portion of TOLED display 50, it may be desirable to anneal a parylene-based polymer passive layer to improve the crystallinity and/or dimensional stability of the material. However, organic light-emitting layers may be damaged under the elevated temperatures of the annealing processes described above. Therefore, instead of annealing parylene-based polymer layers deposited after deposition of the cathode and organic light-emitting layers, the deposition conditions can be optimized to provide for a desired physical characteristic.

For example, it is desirable for encapsulant layer 80 to have low water and oxygen permeabilities. Annealing a PPX-F film to increase the beta-2 crystallinity of the material has been determined to improve the moisture and oxygen barrier properties of the film. However, because encapsulant layer 80 is deposited after organic light-emitting layer 74, annealing may damage organic light-emitting layer 74. Therefore, the deposition conditions for encapsulant layer 80 may be optimized to provide a film with sufficient moisture and oxygen barrier properties without annealing.

Table I below shows the results of a series of experiments to optimize the deposition conditions for PPX-F and PPX-N encapsulant films to obtain satisfactory moisture and oxygen barrier characteristics without annealing. The barrier characteristics of the films were tested by first adhering particles of calcium sulfate doped with CoCl₂ to a silicon wafer substrate. The particles were adhered to the wafer using a non-water-absorbing polysiloxane adhesive. Next, PPX-F and PPX-N films were deposited over the particles to encapsulate the particles and the adhesive. No inorganic encapsulant layers were used. After encapsulation, the samples were removed from vacuum and exposed to ambient in the presence of a control sample made up of unencapsulated calcium sulfate particles. Cobalt chloride turns from blue to pink in color when exposed to moisture absorbed by the calcium sulfate. Therefore, the particles were monitored for change in color to determine approximate rates of oxygen and water permeabilities.

The unencapsulated calcium sulfate particles showed a lifetime of approximately 20 minutes when exposed to ambient. The lifetime of the calcium sulfate particles encapsulated by unannealed PPX-F and PPX-N films deposited under a series of substrate temperatures are as follows. The depositions were performed using feed rates ranging from 3-5 sccm for PPX-F, and a dimer temperature of about 100C for PPX-N.

TABLE I

| | Substrate | | |
|---|---|---|---|
| | Temperature | Deposition Rate | Lifetime |
| Encapsulant | (° C.) | (Å/minute) | (Hours/um film) |
| PPX-N | 0 | 675 | 9 |
| | −10 | 1000 | 9 |
| | −20 | 1167 | 5 |
| | −30 | 1265 | 2 |
| PPX-F | 10 | 120 | 48 |
| | −10 | 375 | 33 |
| | −20 | 570 | 28 |
| | −40 | 1000 | 15 |

Because the moisture and oxygen permeabilities of PPX-F and PPX-N films are known to improve with annealing, and because annealing is known to improve crystallinity, it would be expected for the moisture and oxygen barrier characteristics to improve with decreasing substrate temperature during deposition, as lower substrate temperatures are associated with higher initial (i.e. as-deposited) crystallinity of the films. However, as can be seen in Table I, moisture and oxygen barrier characteristics of the films actually improved with increasing substrate temperature. This indicates that further experimentation with deposition rates and substrate temperatures may allow the deposition conditions to be optimized for desired barrier properties and throughput rates in production.

The various passive polymer layers and fabrication processes described above in the context of TOLED display 50 may be extended to other display architectures. FIGS. 4-6 illustrate some other exemplary OLED display architectures to which these ideas may be extended.

First, FIG. 4 shows a greatly magnified, schematic depiction of an exemplary BOLED display, generally at 100. BOLED display 100 includes a substrate 102, a TFT control portion 104 formed on the substrate 102, and an intermetal dielectric layer 106 disposed between the TFT portion 104 and an OLED portion 108 of the display that insulates interconnects 110 extending between the TFT portion and OLED portions of the display.

OLED portion 108 of BOLED display 100 includes various active and passive layers. For example, OLED portion 108 includes a transparent anode 112, for example, ITO, electrically connected to each interconnect 110, a plurality of separators 114 for separating adjacent pixels, one or more layers of organic light-emitting materials (shown as a single layer 116) disposed between separators 114, a thin barrier layer 118 formed over the organic light-emitting layer 116, and a cathode 120 formed from a low work constant material, for example, a Ca—Li composite structure. In contrast to TOLED 50, BOLED 100 includes a transparent substrate, and the transparent electrode is formed on the substrate side of the device. Light is therefore emitted through the substrate, as shown by arrow 122. After depositing cathode 120, BOLED display 100 is typically encapsulated (encapsulant layer not shown) to protect the BOLED from the external environment.

BOLED display 100 may be fabricated using system 10 in a manner similar to that described above for TOLED display 50. Furthermore, as with TOLED display 50, each passive layer in OLED portion 108 of BOLED display 100 may be formed from a single suitable polymer material, including but not limited to PPX-F.

An exemplary order of process steps for forming BOLED display 100 with PPX-F passive layers is as follows. First, the TFT structures are formed. Next, interconnects 110 are formed by sputter depositing a layer of aluminum (or other metal) over the TFT structures, and then patterning and dry etching of the aluminum to form interconnects. Each of these processes may be performed in TFT section 12 of deposition system 10. Next, the substrate is transferred to OLED section 14 of deposition system 10, and a PPX-F intermetal dielectric layer 106 is deposited. At this time, intermetal dielectric layer 106 may be annealed if desired. After deposition and optional anneal of the PPX-F intermetal dielectric layer 106, intermetal dielectric layer 106 is patterned and etched to expose interconnects 110. Next, transparent anode 112 is deposited via sputtering, and then patterned and etched appropriately. Application and patterning of photoresist may be performed outside of system 10, and etching may be performed in plasma etching chamber 22.

Next, separators 114 are formed by depositing a 2-3 micron-thick layer of PPX-F. Because cathode 120 and organic light-emitting layer 116 have not yet been deposited at this time, the layer of PPX-F for forming the separators may be annealed if desired. However, the desired physical properties of the PPX-F used for the separators may not require annealing to achieve.

After depositing the separator layer of PPX-F, separators 114 are formed by patterning and etching the PPX-F layer. At this time, organic light-emitting layer(s) 116 may be deposited between separators 114 via inkjet printing, thermal evaporation, or other suitable method.

Next, a thin layer of PPX-F, on the order of 10-30 angstroms, is deposited as barrier layer 118, and then cathode 120 is deposited via sputtering. Finally, an encapsulant layer or layers may be deposited over cathode 120 for protection. It will be appreciated that each of the processing steps for forming OLED portion 108 of BOLED display 100 may be performed in OLED section 14 of the depicted deposition system 10, with the exception of some of the lithographic processes. Substrates may simply be removed from deposition system 10 for lithographic processes, and re-inserted for continued processing.

FIG. 5 shows, generally at 200, a greatly magnified, schematic depiction of a bottom-emitting polymer light-emitting device (BPLED) display that can be fabricated using system 10. A PLED differs from an OLED primarily in the size of the light-emitting organic molecules. Whereas organic light-emitting materials of OLEDS are generally small molecules, the organic light-emitting materials of PLEDs are polymers with much larger molecular weights. Both BPLEDs and TPLEDs (top-emitting polymer light-emitting devices) are known, and it will be appreciated that much of the discussion herein of the depicted BPLED also applies to a TPLED.

BPLED display 200 includes a transparent substrate 202, a TFT portion 204, and a PLED portion 206. An intermetal dielectric layer 208 is disposed between the TFT portion 204 and the PLED portion 206 of the display to insulate interconnects 210 extending between the TFT portion and OLED portions of BPLED display 200. Intermetal dielectric layer 208 may be formed from a passive polymer layer as described herein, including but not limited to PPX-F. Furthermore, because intermetal dielectric layer 208 is formed before the deposition of the polymer light-emitting layers, intermetal dielectric layer 208 may be annealed after deposition, for example, if a higher crystallinity or a beta-1 or beta-2 phase material is desired for a PPX-F intermetal dielectric layer 208.

PLED portion 206 of BOLED display 100 includes various active and passive layers. For example, PLED portion 206 includes a transparent anode 212 electrically connected to each interconnect 210, a well structure 214 for holding the polymer light-emitting material for each pixel, one or more layers of organic light-emitting materials (shown as a hole transport layer 216 and a polymer light-emitting layer 218) disposed in well structure 214, a thin barrier layer 220 formed over the hole transport and polymer light-emitting layers 216, 218, and a cathode 222 formed from a low work constant material. The organic hole-transport layer 216 is deposited using a thermal evaporation chamber. A planarization and/or encapsulation layer 224 is typically formed over the other PLED layers to protect the device from moisture, and to provide a planar surface for any further device fabrication steps. While only a single well structure is shown in FIG. 5, it will be appreciated that a PLED display will typically include a large number of closely-spaced well structures.

Well structure 214 is formed by first depositing a 2-3 micron layer of dielectric material 226, and then patterning and etching the layer to form well structure 214. Application and patterning of photoresist may be performed outside of system 10, and etching may be performed in plasma etching chamber 22.

Well layer 226 may be formed from the same polymer material as intermetal dielectric layer 208. In the specific example of a PPX-F 226, the PPX—F layer may also be annealed if desired, as this layer is deposited prior to the deposition of the polymer light-emitting layer 218 and the cathode 222. The use of well structure 214 allows the polymer light-emitting material to be deposited via inkjet printing into the well. Other passive layers that may be formed from the same polymer as intermetal dielectric layer 208 and well layer 226 include, but are not limited to, barrier layer 220 and encapsulant layer 224. Fabrication processes of each of these layers are similar to those processes described above, and are therefore not described in more detail.

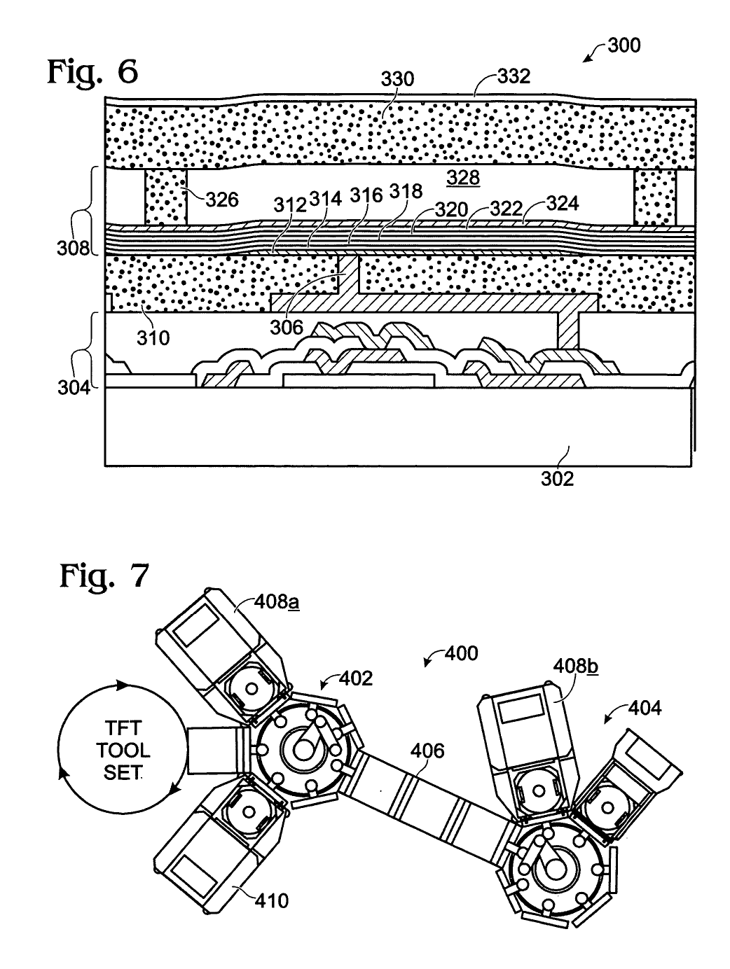

FIG. 6 shows, generally at 300, a greatly magnified, schematic depiction of an exemplary OLED-on-Si display that can be fabricated using system 10. The depicted OLED-on-Si display differs from some of the other displays shown herein in that the device includes organic light-emitting materials configured to emit white light, and color filters configured to filter out unwanted colors. OLED-on-Si display 300 includes a single crystal silicon substrate 302, and a TFT portion 304 formed on and integrated with substrate 302. A metal interconnect 306 extends from TFT portion 302 to an OLED portion 308. TFT portion 304 and OLED portion 308 are separated by a passive intermetal dielectric layer 310 that surrounds interconnect 304.

OLED portion 308 of OLED-on-Si display 300 includes a metal anode 312 (for example, aluminum), and a plurality of light-emitting layers, including a hole injection layer 314, a hole transport layer 316, a doped electron transport layer 318, and an electron injection layer injection layer 320. These layers may be deposited in system 10 by substituting organic light-emitting material deposition chambers 36, 38 and 40 with other suitable chambers, attaching additional deposition chambers to system 10, and/or utilizing separate tool sets for forming the light-emitting layers. OLED portion 308 also includes a thin barrier layer 322 formed over the electron injection layer, and a transparent cathode 324 formed over the barrier layer. Encapsulant layer 326 may be formed over transparent cathode 324 to protect the device from an external atmosphere. Barrier layer 322 and encapsulant layer 326 may each be formed from a single polymer (which may be the same polymer as intermetal dielectric layer 310), and may be deposited in a single polymer deposition chamber, as described above for other embodiments. Other layers shown for OLED-on-Si display 300 include black matrix stripes 326, color filters 328 for filtering white light produced by the organic light-emitting layers, a transparent protective layer 330 and an antireflective coating 332. Transparent protective layer 330 protects color filters 328 from damage during the deposition of antireflective coating 332, and may be made from the same polymer as intermetal dielectric layer 310, barrier layer 322 and encapsulant layer 326. In a specific embodiment, each of these layers is formed from PPX-F.

FIG. 7 shows, generally at 400, another exemplary embodiment of a system for producing both the TFT and OLED portions of an OLED display. System 400 includes a TFT fabrication section 402 and an OLED fabrication section 404 similar to those described above for system 10, but the two sections are connected by a linear organic color emitter deposition tool 406. Because process flow through linear organic color emitter deposition tool 406 is typically unidirectional, polymer deposition chambers 408, 408a are provided in both the TFT fabrication section 402 and the OLED fabrication section 404. This is so that passive polymer layers can be deposited both before and after the deposition of organic light emitting materials. This offers the additional advantage that interconnects extending between the TFT and OLED (or PLED) portions of the displays shown herein can be covered with the protective intermetal dielectric layer immediately after they have been etched in plasma etching chamber 410, rather than being transferred from TFT transfer chamber 18 to OLED transfer chamber 30 prior to depositing the intermetal dielectric layer.

Although the present disclosure includes specific embodiments of OLED and PLED displays and methods of forming the displays, specific embodiments are not to be considered in a limiting sense, because numerous variations are possible. The subject matter of the present disclosure includes all novel and nonobvious combinations and subcombinations of the various films, processing systems, processing methods and other elements, features, functions, and/or properties disclosed herein. The description and examples contained herein are not intended to limit the scope of the invention, but are included for illustration purposes only. It is to be understood that other embodiments of the invention can be developed and fall within the spirit and scope of the invention and claims.

The following claims particularly point out certain combinations and subcombinations regarded as novel and nonobvious. These claims may refer to “an” element or “a first” element or the equivalent thereof. Such claims should be understood to include incorporation of one or more such elements, neither requiring nor excluding two or more such elements. Other combinations and subcombinations of features, functions, elements, and/or properties may be claimed through amendment of the present claims or through presentation of new claims in this or a related application. Such claims, whether broader, narrower, equal, or different in scope to the original claims, also are regarded as included within the subject matter of the present disclosure.

1. An organic light-emitting display, comprising:
a thin film transistor portion including an array of thin film transistors; and
a light-emitting portion including an array of organic light-emitting elements in electrical communication with the array of thin film transistors, wherein the light-emitting portion is formed from a plurality of layers of materials, and wherein the plurality of layers of materials in the light-emitting portion includes a plurality of passive polymer layers each formed from a single polymer material.

2. The organic light-emitting display of claim 1, wherein the polymer material is formed by transport polymerization.

3. The organic light-emitting display of claim 1, wherein the polymer material has a repeating unit of —CF₂C₆H₄CF₂—.

4. The organic light-emitting display of claim 1, wherein the polymer material has a crystallinity of at least 10%.

5. The organic light-emitting display of claim 1, wherein the plurality of passive polymer layers includes a barrier layer, and wherein the barrier layer is disposed between an electrode layer and an organic light-emitting layer.

6. The organic light-emitting display of claim 1, wherein the plurality of passive polymer layers includes an encapsulant layer for protecting the organic light-emitting display from an external atmosphere.

7. The organic light-emitting display of claim 1, wherein the plurality of passive polymer layers includes a layer for defining structures for holding and separating organic light emitting materials of different colors.

8. The organic light-emitting display of claim 1, further comprising an inter-metal dielectric layer disposed between the thin film transistor portion and the light-emitting portion, wherein the inter-metal dielectric layer is made from the same polymer material as the passive polymer layers in the light-emitting portion.

9. The organic light-emitting display of claim 1, wherein the plurality of passive polymer layers includes a planarization layer.

10. The organic light-emitting display of claim 1, further comprising a color filter layer and an anti-reflective layer, and plurality of passive polymer layers includes a protective layer disposed between the color filter layer and the antireflective layer.

11. The organic light-emitting display of claim 1, wherein the polymer material has a repeat unit of —CZZ′C₆H_{4-y}X_{y}CZ″Z′″-, wherein Z, Z′, Z″ and Z′″ are similar or different and each is H, a halogen, or a phenyl moiety;
y is 0 or an integer equal to or between 1 and 4; and
X is H or a halogen.

12. An organic light-emitting display, comprising:
a thin film transistor portion including a plurality of thin film transistors;
a light-emitting portion including a plurality of organic light-emitting elements in electrical communication with the plurality of thin film transistors, wherein the light-emitting portion is formed from a plurality of layers of materials, the plurality of layers of materials including a plurality of passive polymer layers; and
a polymer dielectric layer disposed between the thin film transistor portion and the light-emitting portion, wherein the polymer dielectric layer disposed between the thin film transistor portion and the light-emitting portion and at least one of the plurality of passive polymer layers in the light-emitting portion are formed from the same polymer material.

13. The organic light-emitting display of claim 2, wherein the polymer material is formed via transport polymerization of a thermally-produced diradical intermediate.

14. The organic light-emitting display of claim 2, wherein the polymer material is selected from the group of polymer materials having a repeating unit of —CZZ′ArCZ″Z′″, wherein Z, Z′, Z″ and Z′″ are similar or different and each is H, a halogen, or a phenyl moiety;
Ar is an aromatic moiety
y is 0 or an integer equal to or between 1 and 4; and
X is H or a halogen.

15. The organic light-emitting display of claim 14, wherein the polymer material has a repeating unit of —CF₂C₆H₄CF₂—.

16. The organic light-emitting display of claim 15, wherein the polymer material has a crystallinity of at least 10%.

17. The organic light-emitting display of claim 2, wherein the plurality of passive polymer layers includes a barrier layer disposed between an electrode layer and an organic light-emitting layer.

18. The organic light-emitting display of claim 2, wherein the plurality of passive polymer layers includes an encapsulant layer for protecting the organic light-emitting display from an external atmosphere.

19. The organic light-emitting display of claim 2, wherein the plurality of passive polymer layers includes a layer for defining structures for holding and separating organic light emitting materials of different colors.

20. The organic light-emitting display of claim 2, further comprising a color filter layer and an antireflective layer, wherein the plurality of passive polymer layers includes a protective layer disposed between the color filter layer and the antireflective layer.

21. The organic light-emitting display of claim 2, wherein the polymer dielectric layer disposed between the thin film transistor portion and the light-emitting portion and all of the plurality of passive polymer layers in the light-emitting portion are formed from a same polymer material.

22. The organic light-emitting display of claim 2, wherein the plurality of passive polymer layers includes a planarization layer.
